(19) United States
(12) Patent Application Publication
(10) Pub. No.: US 2013/0270915 A1
(43) Pub. Date: Oct. 17, 2013

(54) ELECTRIC POWER CONVERSION APPARATUS AND METHOD IN ENERGY HARVESTING SYSTEM

(71) Applicant: Electronics and Telecommunications Research Institute, (US)

(72) Inventors: Kyung Hwan PARK, Daejeon (KR); Sung Weon KANG, Daejeon (KR); In Gi LIM, Daejeon (KR); Chang Hee HYOUNG, Daejeon (KR); Tae Young KANG, Seoul (KR); Byoung Gun CHOI, Daegu (KR); Sung Eun KIM, Seoul (KR); Jung Hwan HWANG, Daejeon (KR); Kyung Soo KIM, Daejeon (KR); Jung Bum KIM, Daejeon (KR); Hyung-Il PARK, Daejeon (KR); Tae Wook KANG, Daejeon (KR)

(73) Assignee: Electronics and Telecommunications Research Institute, Daejeon (KR)

(21) Appl. No.: 13/763,527

(22) Filed: Feb. 8, 2013

(30) Foreign Application Priority Data
Apr. 17, 2012 (KR) 10-2012-0039815

(51) Int. Cl. H02J 4/00

(52) U.S. Cl. CPC H02J 4/00
USPC 307/71

(57) ABSTRACT

Disclosed are an electric power conversion apparatus and method in an energy harvesting system. In more detail, it is possible to obtain the maximum electric power from the plurality of energy sources by selecting the connection structure between the source terminals or the connection structure between the source terminals and the collection terminals using the electrical characteristic values (for example, open voltage, short current, and internal impedance) of each source and adjusting the load impedance in the selected connection structure in the energy harvesting system.

### CROSS-REFERENCE TO RELATED APPLICATIONS

This application is based on and claims priority from Korean Patent Application No. 10-2012-0039815, filed on Apr. 17, 2012, with the Korean Intellectual Property Office, the disclosure of which is incorporated herein in its entirety by reference.

### TECHNICAL FIELD

The present disclosure relates to an electric power conversion apparatus and a method in an energy harvesting system, and more particularly, to an electric power conversion apparatus and a method in an energy harvesting system capable of obtaining maximum electric power from a plurality of energy sources by selecting a connection structure between source terminals or a connection structure between source terminals and collection terminals, by using electrical characteristic values (for example, open voltage, short current, and internal impedance) of each source and adjusting load impedance in the selected connection structure.

### BACKGROUND

Energy harvesting means obtaining pollution-free electric energy from natural or human activities. As the energy harvesting method, there are a technology of producing relatively large electric power such as photovoltaic power generation, tidal power generation, wind power generation, and the like, and a technology of obtaining small electric power from physical exercise, body heat, or floating propagation.

In the photovoltaic power generation system, voltage that can be generated by a single photovoltaic (PV) cell such as a solar cell is only about 0.5 V. Therefore, a solar cell module is configured by connecting several solar cells in series. A plurality of solar cell modules is connected with each other so as to be configured as a solar cell panel. A plurality of panels is arranged to be connected with each other, thereby obtaining user desired large electric power. The reason is that electrical characteristic values (for example, voltage, current, internal impedance) from one PV cell are substantially the same for each cell, thereby increasing electric power when several cells are connected.

However, when a deviation in electrical characteristic values for each cell is large, a large amount of electric power is not generated even though several cells are connected. The reason is that the non-uniform electrical characteristics cause mutual interference to put a brake on an increasing rate (for example, an increasing rate of available electric power due to the increase in the number of cells) of available electric power that can be transmitted to loads.

For this reason, it is more difficult to use other types of energy sources together. For example, the case in which both of the PV cell and a thermoelectric generator cell (TEG cell) such as a thermoelectric generator are used can more reduce the available electric power than the case in which only one of the PV cell and the thermoelectric generator is used. As a result, it is most preferable to use a plurality of same energy source cells. The reason is that the electrical characteristic values are uniform.

However, if the above conditions are not permitted, for example, if the number of arranged cells is increased and the volume and weight of the photovoltaic power generation system are increased accordingly, and as a result, the photovoltaic power generation system is difficult to carry, various types of energy source cells are unavoidably tied.

Theoretically, a method of deriving maximum electric power from a source that is an apparatus generating electric energy matches impedance of a load that is an apparatus consuming electric energy with source impedance. When a source is one, the load impedance is adjusted so as to be matched with the source impedance. When a plurality of sources is connected, the impedance in a source direction is changed according to a connection structure between the sources. Therefore, there is a problem in that the load impedance needs to be newly matched whenever the impedance is changed.

Even though the load impedance is matched with the impedance of a circuit to which the plurality of sources is connected, the load impedance is not matched with each source, such that the available electric power of each source is not used maximally.

### SUMMARY

The present disclosure has been made in an effort to provide an electric power conversion apparatus and a method in an energy harvesting system capable of obtaining maximum electric power from a plurality of energy sources by selecting a connection structure between source terminals or a connection structure between source terminals and collection terminals, by using electrical characteristic values (for example, open voltage, short current, and internal impedance) of each source and adjusting load impedance in the selected connection structure.

An exemplary embodiment of the present disclosure provides an electric power conversion apparatus in an energy harvesting system, including: a central control unit configured to use electrical characteristic values of each source terminal connected to a plurality of energy sources as input parameters to calculate a serial and/or parallel combination; an electric power combining unit configured to measure the electrical characteristic values of each source selected from a plurality of source terminals and transfer the measured electrical characteristic values to the central control unit, connect each source terminal in the serial or parallel combination according to the calculated serial-parallel combination results and match impedance between the source terminals and the load terminals connected in series or in parallel; and a voltage converting unit configured to be connected to the load terminal and convert an electric power signal collected by the electric power combining unit to generate power supply voltage.

Another exemplary embodiment of the present disclosure provides an electric power conversion method in an energy harvesting system, including: measuring electrical characteristic values of each source terminal selected from a plurality of source terminals; calculating a serial and/or parallel combination by using electrical characteristic values of each source terminal connected to a plurality of measured energy sources as input parameters; connecting each source terminal according to the calculated serial and/or parallel combination results based on the serial or parallel combination; matching impedance between the source terminals and load terminals connected in series or in parallel; and generating power supply voltage by converting an electric power signal collected from the impedance matched source terminals.

According to the exemplary embodiments of the present disclosure, it is possible to obtain the maximum electric power from the plurality of energy sources by selecting the connection structure between the source terminals or the connection structure between the source terminals and the collection terminals using the electrical characteristic values (for example, open voltage, short current, and internal impedance) of each source and adjusting the load impedance in the selected connection structure in the energy harvesting system.

According to the exemplary embodiments of the present disclosure, it is possible to prevent a considerable portion of the electric power to be transferred to the loads from being consumed in the internal impedance of the connected sources by performing the relative comparison by previously measuring the electrical characteristics of each source, generating the control signals determining the serial and/or parallel connection between the source terminals and between the source terminals and the collection terminals, and connecting the actual circuit in series and in parallel according to the control signals.

In detail, according to the exemplary embodiments of the present disclosure, it is possible to use the serial circuit, the parallel circuit, or the serial and/or parallel mixing circuit together by extracting the electrical characteristic values of each source and selecting the serial and/or parallel circuits for each source using the disconnecting and/or connecting switches for each source to interrupt the input from the specific source.

According to the exemplary embodiments of the present disclosure, it is possible to obtain electric power capable of driving and charging electronic devices from various types of energy sources (for example, piezoelectric shoes, solar fiber jacket, dielectric elastomer clothes, thermoelectric module, radio noise, and the like) even at locations where electricity is absent, by collecting several small electric power sources to obtain the increased electric power.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram of an electric power conversion apparatus in an energy harvesting system according to an embodiment of the present disclosure.

FIG. 2 is a configuration diagram of an electric power combining unit of FIG. 1 according to the exemplary embodiment of the present disclosure.

FIG. 3 is a detailed configuration diagram of an input select unit, a serial and/or parallel combining unit, a voltage and/or current measuring unit, and an impedance adjusting unit of FIG. 2 according to the exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

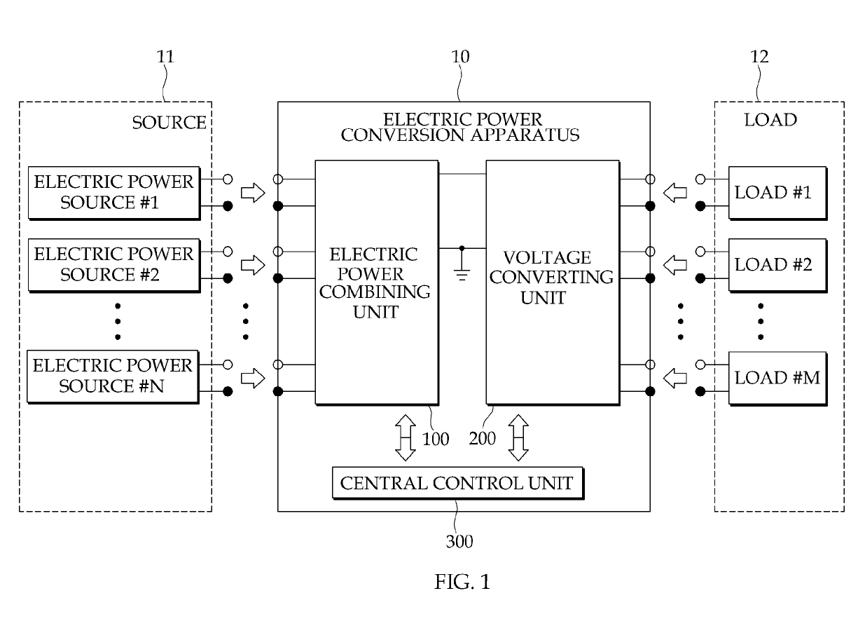

FIG. 1 is a configuration diagram of an electric power conversion apparatus in an energy harvesting system according to an embodiment of the present disclosure.

As shown in FIG. 1, an energy harvesting system includes sources 11 and an electric power conversion apparatus 10. In this configuration, the power conversion apparatus 10 is connected to a load 12 to supply electric power to the load 12.

The electric power conversion apparatus 10 receives a signal from at least two input terminals connected to the sources 11 to combine electric power so that the electric power conversion apparatus 10 collects each electric power from the sources 11 including a plurality of electric power sources #1, #2, . . . , #N in the energy harvesting system to obtain the increased electric power. In other words, the electric power conversion apparatus 10 adjusts and couples impedance to maximally use available electric power of each source, thereby generating maximum electric power.

Therefore, the electric power conversion apparatus 10 adjusts a connection structure between the sources 11 based on the electrical characteristic values of each source and adjusts impedance of the load 12 including loads #1, #2, . . . , #N according to the connection structure, thereby overcoming inefficiency at the time of the electric power conversion.

To this end, the power conversion apparatus 10 measures the electrical characteristic values of each source. In the electric power conversion apparatus 10, when intending to connect several electric power sources, the electric power sources are connected in series or in parallel. The electric power conversion apparatus 10 analyzes the electrical characteristic values of each power source to generate control signals selecting a method of connecting several electric power sources with each other. The electric power conversion apparatus 10 adjusts the input impedance.

That is, the electric power conversion apparatus 10 uses the electrical characteristic values (for example, open voltage, short current, and internal impedance) of each power source as input parameters to determine a connection method between the source terminals or a connection method between the source terminals and the collection terminals. Here, the open voltage of the electrical characteristic values indicates voltage when there are no loads in each source terminal. The short current indicates current flowing in terminals when each source terminal is short-circuited. The internal impedance is defined as the open voltage and/or short current value.

When the electric power sources are connected in series, current flowing in all the connected circuits follows the smallest short current value among the sources. On the other hand, when the electric power sources are connected in parallel, voltage of all the circuits follows the lowest open voltage value among the sources. By doing so, a considerable portion of electric power to be transferred to the loads is consumed in the internal impedance of the connected electric power sources.

To prevent this situation, the electric power conversion apparatus 10 according to the exemplary embodiment of the present disclosure previously detects the electrical characteristic values of each source to perform the relative comparison. As a result, the control signals determining the serial or parallel connection between the source terminals and between the source terminals and the collection terminals are generated and the actual circuits are selectively connected in series or in parallel according to the control signals.

The electric power conversion apparatus 10 may select the serial and/or parallel connection for each source. Generally, the electric power conversion apparatus 10 performs the connection to implement the serial circuit, the parallel circuit, or the serial and/or parallel circuit together. The electric power conversion apparatus 10 extracts the electrical characteristic values of each source and uses disconnecting and/or connecting switches for each source to interrupt an input from a specific source.

The available electric power that can be used in the loads is changed according to the connection method of the sources 11. When the impedance of the load 12 is optimally adjusted, the electric power consumed in the loads is maximal, which is referred to as the available electric power.

However, the connection structure between the sources 11 is changed, the optimal load impedance is also changed and the available electric power is changed accordingly. Therefore, when the connection structure between the sources 11 is changed by the serial and/or parallel control, the available electric power is also increased and decreased. In this case, it is assumed that the impedance of the load 12 is optimally adjusted. As a result, the electric power conversion apparatus 10 adjusts the connection structure so that the available electric power is maximal. To this end, the electric power conversion apparatus 10 uses the electrical characteristic values of each source as the input parameters to perform the analysis, which follows a separate algorithm. The algorithm is created based on a circuit network analysis, but may be changed according to purposes and references and therefore, the detailed description thereof will be omitted herein.

The electric power conversion apparatus 10 selects the connection structure between the terminals and optimally adjusts the impedance of the load 12 to obtain the maximum electric power.

Consequently, the electric power conversion apparatus 10 collects the sources 11 including several electric power sources to obtain the increased electric power, thereby obtaining the electric power capable of driving and charging electronic devices from several electric power sources (for example, piezoelectric shoes, solar fiber jacket, dielectric elastomer clothes, thermoelectric module, radio noise, and the like) even at locations where electricity is absent.

Meanwhile, as shown in FIG. 1, the electric power conversion apparatus 10 according to the exemplary embodiment of the present disclosure includes an electric power combining unit 100, a voltage converting unit 200, and a central control unit 300.

Hereinafter, each component of the electric power conversion apparatus 10 according to the exemplary embodiment of the present disclosure will be described.

The electric power combining unit 100 measures the electrical characteristic values of each source selected from the plurality of source terminals and transfers the measured electrical characteristic values to the central control unit 300, connects each source terminal in a serial or parallel combination according to the calculated serial and/or parallel combination results and matches the impedance between the source terminals and the load terminals connected in series or in parallel.

The voltage converting unit 200 is connected to the load terminal and converts the electric power signal collected in the power combining unit to generate power supply voltage. For example, the voltage converting unit 200 uses the collected power to generate power supply voltage for portable electronic devices and power supply voltage for internal circuits.

The central control unit 300 uses the electrical characteristic values of each source terminal connected to the plurality of energy sources as the input parameters to calculate the serial and/or parallel combination. In this case, the central control unit 300 uses at least one of the open voltage, the short current, and the internal impedance that are the electrical characteristic values of each source terminal to calculate the serial and/or parallel combination.

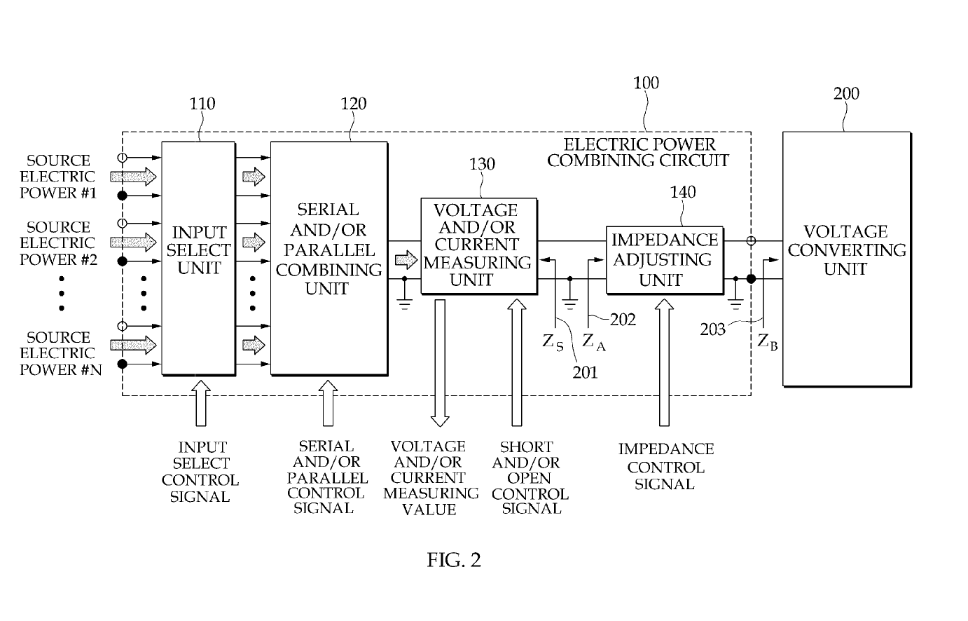

FIG. 2 is a configuration diagram of an electric power combining unit of FIG. 1 according to the exemplary embodiment of the present disclosure.

As shown in FIG. 2, the electric power combining unit 100 includes an input select unit 110, a serial and/or parallel combining unit 120, a voltage and/or current measuring unit 130, and an impedance adjusting unit 140.

The input select unit 110 selects each source terminal from the plurality of source terminals.

The serial and/or parallel combining unit 120 connects the connection structure between each source terminal or the connection structure between the source terminals and the collection terminals according to the serial and/or parallel combination results calculated by the central control unit 300 based on the serial or parallel combination. In this case, the serial and/or parallel combining unit 120 selects any one of interruption or pass of the electric power signals input from between each source terminal and from between the source terminals and the collection terminals according to the control signals of the central control unit 300. The serial and/or parallel combining unit 120 individually selects the serial or parallel connection for each source terminal.

Here, the control signals for the serial and/or parallel combination are generated from the central control unit 300. The central control unit 300 uses the electrical characteristic values (for example, open voltage, short current, and internal impedance) of each source as the input parameters to calculate the optimal serial and/or parallel combination. Therefore, the central control unit 300 receives the open voltage and the short current measured by the voltage and/or current measuring unit 130 as the input parameter values, for each source selected by the input select unit 110. The central control unit 300 may use the internal impedance as the open voltage and/or short current values without being separately measured.

The voltage and/or current measuring unit 130 measures the electrical characteristic values of each source terminal selected by the input select unit 100 and transfers the measured electrical characteristic values to the central control unit 300. At the time of measuring the electrical characteristic values, the voltage and/or current measuring unit 130 selectively connects an open circuit or a short circuit across the selected individual source terminal or passes through the signal of the source terminal to measure the open voltage and the short current. Here, the open voltage indicates voltage drop across the (individual source terminal when the open circuit is connected across an output terminal of the apparatus to be measured. The short current indicates current flowing in the short circuit when the short circuit is connected across the output terminal of the apparatus to be measured. The voltage and/or current measuring unit 130 may measure the voltage or current value of the specific terminal.

The impedance adjusting unit 140 adjusts the impedance of the voltage converting unit 200 to match the impedance in the source terminal direction with the impedance in the load terminal direction. The impedance adjusting unit 140 connects the connection structure between the source terminals or the connection structure between the source terminals and the collection terminals based on the serial or parallel connection combination so as to increase the available electric power from the source 11.

Describing in detail, the impedance adjusting unit 140 matches impedance Z_{S} 201 in the source direction with impedance Z_{A} 202 in the load direction. Here, the Z_{A} 202 is affected by the impedance Z_{B} 203 of the voltage converting unit 200. Therefore, the impedance adjusting unit 140 adjusts the impedance Z_{B} 203 to match the impedance. Therefore, the impedance adjusting unit 140 performs an impedance conversion function for two-way matching. Many restrictions in fluctuating the impedance are present and therefore, the two-way matching is performed.

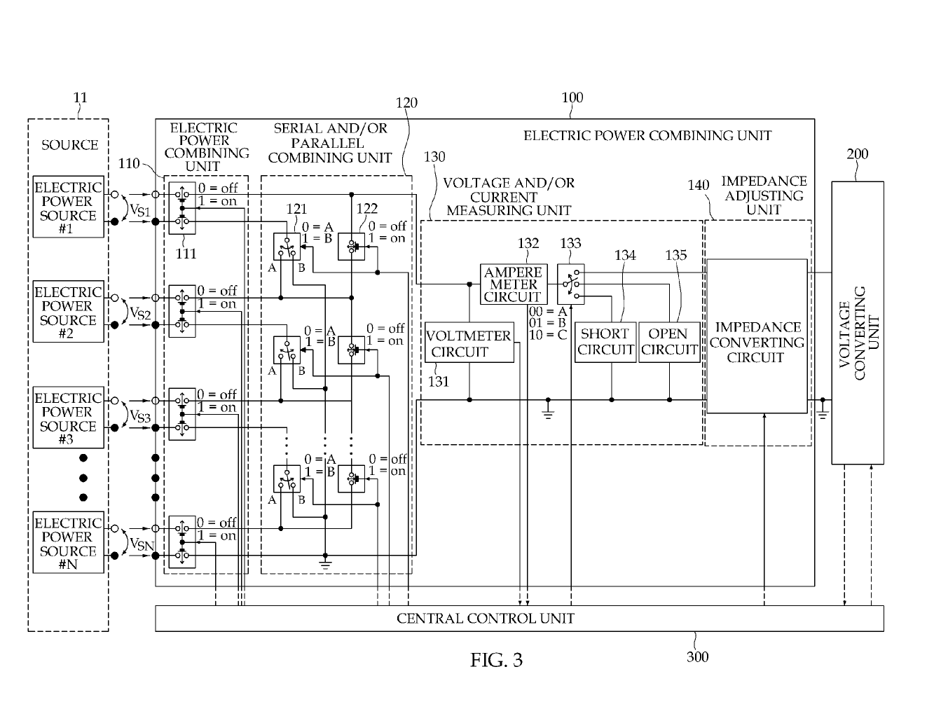

FIG. 3 is a detailed configuration diagram of an input select unit, a serial and/or parallel combining unit, a voltage and/or current measuring unit, and an impedance adjusting unit of FIG. 2 according to the exemplary embodiment of the present disclosure.

As shown in FIG. 3, the serial and/or parallel combining unit 120 includes a select switch 121 and an on and/or off switch 122. The serial and/or parallel combining unit 120 controls two kinds of select switches 121 and the on and/or off switch 122. The two switches are operated by the same serial and/or parallel control signal.

The serial-parallel combining unit 120 connects the connection structure between each source terminal or the connection structure between the source terminals and the collection terminals by controlling the select switch 121 and the on and/or off switch 122 according to the serial-parallel combination results calculated by the central control unit 300 based on the serial or parallel combination. For the serial or parallel connection, the serial and/or parallel combining unit 120 simultaneously controls the select switch 121 and the on and/or off switch 122 according to the serial and/or parallel control signal 123.

For example, when the serial and/or parallel control signal is “0”, the inter-device is connected in series. That is, the select switch 121 is connected to port “B” and the on and/or off switch 122 is “OFF” so as to be disconnected. On the other hand, when the serial and/or parallel control signal is “1”, the inter-device is connected in parallel. That is, the select switch 121 is connected to the port “B” so as to be connected to a common ground line and the on and/or off switch 122 is “ON” to connect non-ground ports between the sources to each other.

As shown in FIG. 3, the voltage and/or current measuring unit 130 includes a voltmeter circuit 131, an ampere meter circuit 132, a triple switch 133, a short circuit 134, and an open circuit 135.

The voltage and/or current measuring unit 130 measures the open voltage and the short current. Meanwhile, the voltage and/or current measuring unit 130 disconnects the connection with the load 12 at the time of measuring the open voltage and the short current. Therefore, the voltage and/or current measuring unit 130 may control the triple select switch 133 to select three connections. The voltage and/or current measuring unit 130 is connected to the impedance control unit 140 at normal times and then, is connected to the open circuit 135 at the time of measuring the open voltage and is connected to the short circuit 134 at the time of measuring the short current.

The impedance adjusting unit 140 couples the electric power signal incoming from at least two input terminals and then, uses the impedance converting circuit for impedance matching with the coupled circuit.

According to the exemplary embodiments of the present disclosure, it is possible to obtain the maximum electric power from the plurality of energy sources by selecting the connection structure between the source terminals or the connection structure between the source terminals and the collection terminals, by using the electrical characteristic values (for example, open voltage, short current, and internal impedance) of each source and adjusting the load impedance in the selected connection structure. In this aspect, the present disclosure is beyond the limitation of the existing technologies and therefore, can be used for the related art and can have sufficient marketability or business possibility of the used apparatus and can be apparently practiced as well as has industrial applicability.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An electric power conversion apparatus in an energy harvesting system, comprising:
a central control unit configured to use electrical characteristic values of each source terminal connected to a plurality of energy sources as input parameters to calculate a serial and/or parallel combination;
an electric power combining unit configured to measure the electrical characteristic values of each source selected from a plurality of source terminals and transfer the measured electrical characteristic values to the central control unit, connect each source terminal in the serial or parallel combination according to the calculated serial-parallel combination results and match impedance between the source terminals and the load terminals connected in series or in parallel; and
a voltage converting unit configured to be connected to the load terminal and convert an electric power signal collected by the electric power combining unit to generate power supply voltage.

2. The electric power conversion apparatus of claim 1, wherein the central control unit uses at least one of open voltage, short current, and internal impedance that are electrical characteristic values of each source terminal to calculate the serial and/or parallel combination.

3. The electric power conversion apparatus of claim 1, wherein the electric power combining unit includes:
an input select unit configured to select each source terminal from the plurality of source terminals;
a voltage and/or current measuring unit configured to measure the electrical characteristic values of the selected each source terminal and transfer the measured electrical characteristic values to the central control unit;
a serial and/or parallel combining unit configured to connect a connection structure between each source terminal or a connection structure between the source terminals and collection terminals based on the serial and/or parallel combination results calculated by the central control unit; and
an impedance adjusting unit configured to adjust the impedance of the voltage converting unit to match impedance in a source terminal direction with impedance in a load terminal direction.

4. The electric power conversion apparatus of claim 3, wherein the voltage and/or current measuring unit selectively connects an open circuit or a short circuit across the selected each source terminal or passes a signal of the source terminal so as to measure open voltage and short current.

5. The electric power conversion apparatus of claim 3, wherein the serial and/or parallel combining unit selects any one of interruption or pass of electric power signals input from between each source terminal or from between the source terminals and the collection terminals according to the control signals of the central control unit.

6. The electric power conversion apparatus of claim 3, wherein the serial and/or parallel combining unit individually selects the serial or parallel connection for each source terminal.

7. The electric power conversion apparatus of claim 3, wherein the serial and/or parallel combining unit connects the connection structure between each source terminal or the connection structure between the source terminals and the collection terminals by a select switch and an on and/or off switch according to the calculated serial-parallel combination results based on a serial or parallel combination.

8. An electric power conversion method in an energy harvesting system, comprising:
measuring electrical characteristic values of each source terminal selected from a plurality of source terminals;
calculating a serial and/or parallel combination by using electrical characteristic values of each source terminal connected to a plurality of measured energy sources as input parameters;
connecting each source terminal according to the calculated serial and/or parallel combination results based on the serial or parallel combination;
matching impedance between the source terminals and load terminals connected in series or in parallel; and
generating power supply voltage by converting an electric power signal collected from the impedance matched source terminals.

9. The electric power conversion method of claim 8, wherein the calculating of the serial and/or parallel combination uses at least one of open voltage, short current, and internal impedance that are electrical characteristic values of each source terminal to calculate the serial and/or parallel combination.

10. The electric power conversion method of claim 8, wherein the measuring of the electrical characteristic values selectively connects an open circuit or a short circuit across the selected each source terminal or passes a signal of the source terminal so as to measure open voltage and short current.

11. The electric power conversion method of claim 8, wherein the connecting of the source terminals selects any one of interruption and pass of electric power signals input from between each source terminal or from between the source terminals and the collection terminals according to the calculated serial and/or parallel combination results.
